(19) United States
(12) Patent Application Publication
(10) Pub. No.: US 2015/0100332 A1
(43) Pub. Date: Apr. 9, 2015

(54) METHOD FOR SHARING PRIVATE NURSING

(71) Applicant: Donald SPECTOR, New York, NY (US)

(72) Inventor: Donald SPECTOR, New York, NY (US)

(21) Appl. No.: 14/109,390

(22) Filed: Dec. 17, 2013

Related U.S. Application Data
(60) Provisional application No. 61/887,390, filed on Oct. 6, 2013.

(51) Int. Cl. G06Q 50/22; G06Q 10/10

(52) U.S. Cl. CPC G06Q 50/22; G06Q 10/10
USPC 705/2

(57) ABSTRACT

A method and system for providing shared private nursing or other healthcare services has a computer with a database for storing patient data and locations. The patients are sorted by location and assigned a nursing rotation for each group of patients at a common location. The services provided to each patient are assigned a numerical value and the value of the services provided to each patient are calculated to determine a percentage of the daily nursing rate attributable to each patient. The patient is then billed only for the percentage of the nurse's time and work that was used over the billing period. The calculations are performed automatically on a computer having a microprocessor after receiving data on the services provided from a personal computer, smartphone or tablet of each nurse.

### CROSS-REFERENCE TO RELATED APPLICATION

This application claims priority under 35 U.S.C. 119(e) of U.S. Provisional Application Ser. No. 61/887,390, filed on Oct. 6, 2013.

### BACKGROUND OF THE INVENTION

1. Field of the Invention

The present invention relates to a method for sharing private duty nursing or other private health care among residents of a common facility. In particular the present invention relates to a computerized method for calculating the amount of care received by each patient from the private duty nursing or other healthcare staff, and billing the patient accordingly.

2. The Prior Art

When people are confined to a hospital, rehabilitation center or assisted living facility, they often require care that exceeds the level provided by the on-site nursing staff. In these situations, people often hire a private duty nurse (PDN). The PDN works directly for the patient, and not for the facility. The level of care provided is excellent, as the PDN staff looks after the patient 24 hours a day. However, the costs can be excessive, and are often beyond what a single patient can afford.

It would be ideal if there were a way for several patients in a single facility to share the cost and services of a single PDN or other private healthcare provider. Currently, no such systems exist.

### SUMMARY OF THE INVENTION

It is therefore an object of the invention to provide a system for providing shared nursing services and calculating the costs to be billed to each patient based on the amount of nursing used.

This object is accomplished by a method for sharing nursing or healthcare services that is run on a computer system having a microprocessor, a storage device, a wireless communication device and software that is programmed to perform the method steps.

First, data of patients requesting private care is entered into the database, either directly at the computer storing the database, or transmitted over the wireless communication network. The patient data includes at least the patients' names and locations but can include other information as well, such as medical history and billing information.

Additionally, a list of common nursing or care services provided by a nursing rotation is entered into the database, along with a corresponding numerical value assigned to each one of the services. The more labor intensive or complicated the service, the higher the numerical value. The numerical value could be a relative value, such as a scale of 1-10, or could be an estimated dollar amount of the value of the service.

The patient data is then sorted by the microprocessor to group the patients according to location. This way, patients in the same facility are grouped together to form a nursing group. The processor automatically assigns the patients in a common location to a single nursing rotation. The software can be programmed to set a limit on the number of patients in a single nursing rotation, so that once that number is exceeded, another nursing rotation is assigned. The number of patients is then spread out among the assigned nurses. For example, if the maximum number of patients per nurse is 4, but there are six patients in a single facility requesting nursing care, then two nurses will be assigned with three patients each. Two more patients can be added to the group without the need for an additional nurse. However, once the ninth patient appears (assuming that none of the original patients drop out) a third nursing rotation will be added. The assignment is dynamic within a facility as the patients are added and drop out.

After the private nursing rotations are assigned to the patients, each service provided to each patient is entered into the database. The processor then automatically assigns a numerical value to each service based on the values already entered in the database for the common services. In addition, the database also stores a daily rate for each nursing rotation in the database. Typically, a nursing rotation will consists of three nurses sharing one 24 hour shift. However, other configurations of the 24 hour shift could also be done, such as 2 nurses on 12 hour shifts, or four or more nurses on shorter shifts.

Once all of the data is entered into the database, the microprocessor, as programmed by the software, calculates a cost per patient in the common location by determining the percentage of the daily rate for each nursing rotation to be assigned to each patient based on the numerical value of the services provided to each patient. The microprocessor then automatically generates an invoice for the cost of the nursing rotation and sends the invoice to each patient over the wireless network or by mail. Typically, the charges are compiled over time and invoices are sent on a monthly basis, but other time frames could be used as well.

In a preferred embodiment, the services provided to each patient are entered into the database via a personal computer, tablet or smartphone of each nurse in the nursing rotation and transmitted over a wireless network to the database. This way, the services can be recorded in real time, as they are being performed. This cuts down on reporting errors and makes it easier for the nurses to keep track of their charges.

Preferably, the tablet, smartphone or personal computer is provided with a custom interface that allows quick entry of the services provided for each patient. The interface contains pre-loaded information about each patient and a checklist of services provided. The nurse merely has to select the service provided from the list each time it is performed. If a service is provided that is not on the list, the nurse can manually enter it and it will be sent to the database over the wireless network, or it can be sent by text message or email. A billing specialist at the database location can then assign a custom value for that charge.

The present invention provides a unique opportunity to provide shared private nursing services to patients in various facilities, at a reduced cost.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a block diagram of the hardware components used in the method according to the invention;

FIGS. 2A and 2B show block diagrams of the internal components of the system;

FIG. 3 shows a view of the interface on a nurse's screen;

FIG. 4 shows a flow diagram of the method steps according to the invention;

FIG. 5 shows a workflow of the allocation of patients to nursing staff in the method according to the invention; and

FIG. 6 shows a sample list of charges entered into the database with the method according to the invention.

### DETAILED DESCRIPTION OF THE PREFERRED EMBODIMENT

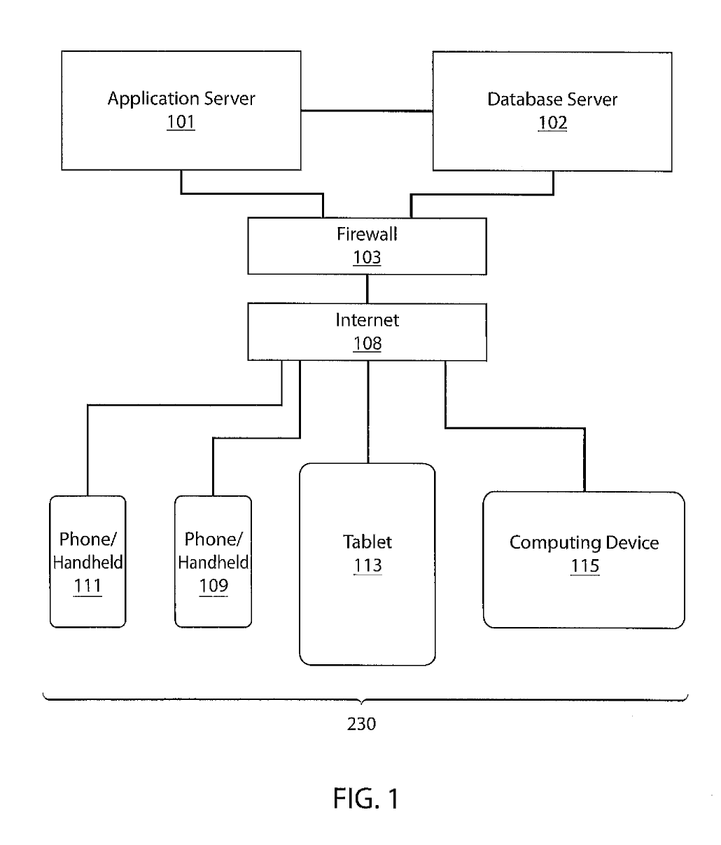

Referring now in detail to the drawings, FIG. 1 shows the components of the system according to the invention. An application server 101 can be connected to a database server 102 and to the internet 108 via a firewall 103. Servers 101 and 102 can communicate with a plurality of personal devices 230 such as phone/handheld 109, 11, tablet 113 and computing device 115. Application server 101 and database server 102 form a computer system 220. Servers 101 and 102 could also be a single integrated server.

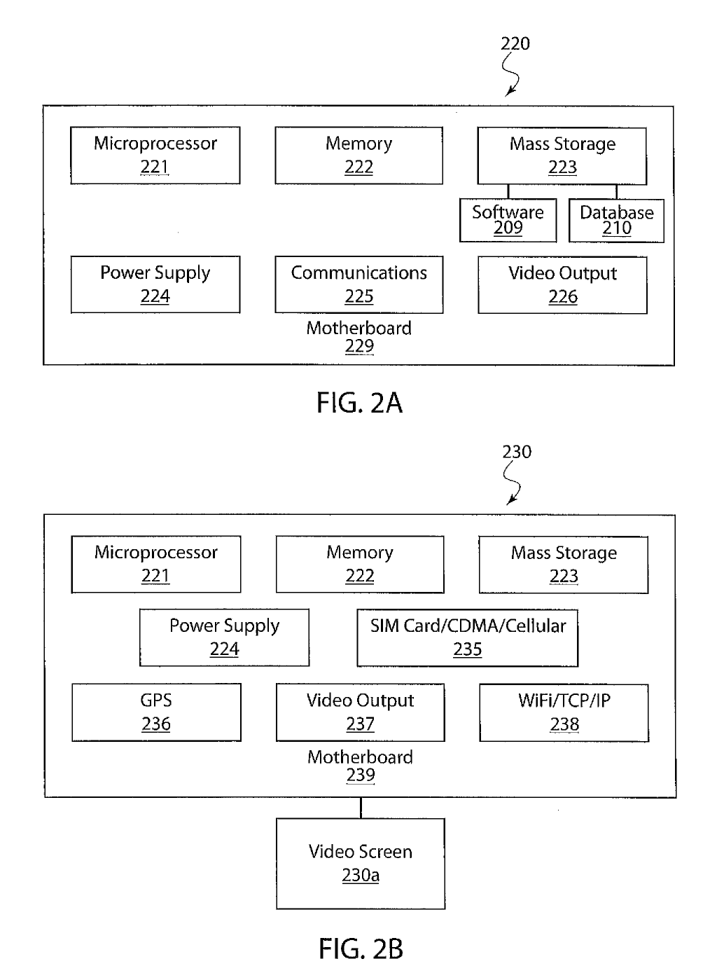

FIGS. 2A and 2B show details of the interior components of servers 101 and 102 (FIG. 2A) and personal devices (FIG. 2B). Each of the servers (or the single server) have a motherboard 229 that contains a microprocessor 221, a power supply 224, a memory 222, a mass storage 223 and a video output 225. In some cases, the memory 222 and mass storage 223 can be combined into a single memory storage device such as a flash memory. Mass storage 223 is ROM and stores the software 209 that runs the system according to the invention. This software 209 when used is called up into memory 222 (RAM memory) and used by microprocessor 221 to perform the tasks of the invention. Communications device 225 can be a modem or any other device that can transmit and receive data over the internet. Data that is input into the system is stored in mass storage device 223 in the form of a searchable database 210. A video output 226 displays data from the database 201.

Computer system 220 communicates with personal device 230 shown in FIG. 2B. Personal device 230 can be a tablet 113, smartphone 111, 109 or personal computing device 115 such as shown in FIG. 1. Each personal device 230 has a motherboard 239 with a microprocessor 231, a memory 232, a mass storage 233, a power supply 234, a video output 237, a GPS (global positioning system) 236, a telephonic communication device 235, such as a SIM card, and a WIFI communication device 238. A video screen 230a displays an interface allowing a user to input information for transfer to computer 220. Communication devices 235 and 238 allow personal device 230 to communicate with computer system 220 and exchange data. As explained below, data regarding patients, nursing rates and services provided is input into computer system 220 and stored as a database 210 in mass storage 223. Computer system 220 communicates with personal device 230 over the internet or other wireless network to exchange data between the nursing rotation and computer system 220.

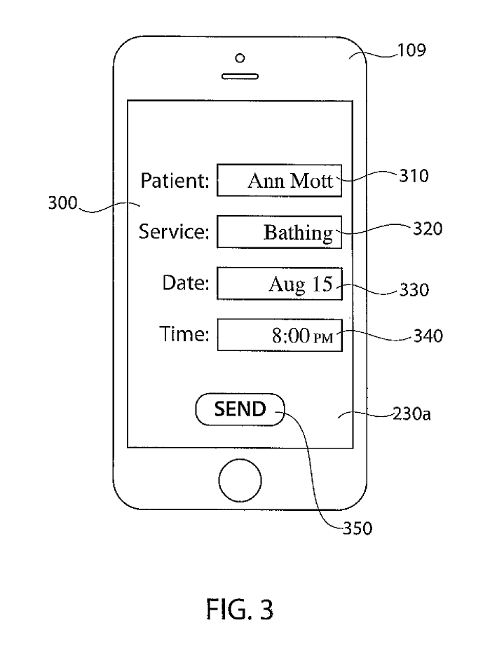

FIG. 3 shows a smartphone 109 with a video display 230a and a customized interface in the form of an application 300 installed on mass storage 233 and accessed by memory 232 for use by microprocessor 231. The application 300 displays a pull-down menu of information for a particular nurse having smartphone 109. The application 300 contains all of the data regarding each patient assigned to a nurse, such as patient names 310. Application 300 also contains a preloaded menu of services provided 320, and allows entry of the date the service is provided 330 and the time the service is provided 340. A “send” button allows the selected information to be immediately sent from smartphone 109 to computer 220 via any available wireless network. For example, if a nurse is assigned to four patients, each patient name is sent to smartphone 109 of the nurse, who only has to select from the group of names in the application. Each of the various services provided by a nurse is also pre-loaded onto application 300, so the nurse only has to select from the list of services. If a service is provided that is not on the list, the nurse can send a custom description to computer system 220 either by text message, email or via an adaption to application 300 that allows custom inputting. The date and time of each service is also entered before sending the information to computer system 220.

Once the information is received by computer system 220, microprocessor 221, using software 210, matches each service with a numerical value, and assigns that value to each patient. At the end of the billing cycle, the daily rate of each nurse is divided by the proportion of the nurses services used by each patient as determined by aggregate numerical value of all services provided to each patient during the billing period.

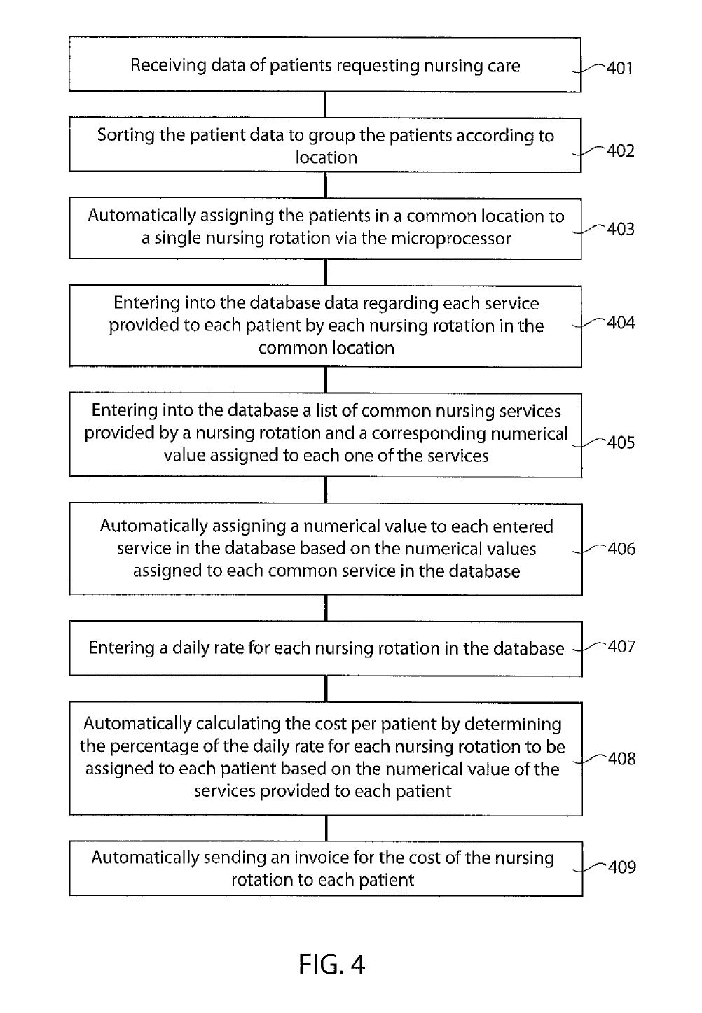

The steps of the method are shown in FIG. 4. In step 401, data of patients requesting nursing care is entered into computer system 220 and stored in storage 223 in the form of a database 210. In step 402, the patient data is sorted by microprocessor 221 using software 209 to group the patents by location, so that all patients in a single location form one or more nursing groups. In step 403, the microprocessor automatically assigns the patients in a common location to a single nursing rotation. The patient data is then sent to the personal device 230 of all nurses in that nursing rotation. In step 404, data for each service provided to each patient is entered into computer system 220 by entering the data via the application 300 on smartphone 109 or any other personal device 230 used by each nurse. The data is then sent over any available wireless network to computer system 220 for storage on mass storage 223.

In step 405, a list of common nursing services is entered into computer system 220, along with a corresponding numerical value for each service. In step 406, microprocessor 221 automatically assigns the designated numerical value to each service that was entered for each patient in step 405, so that each patient has a running tally of services provided and numerical values for each service. In step 407, a daily rate for each nursing rotation is entered into computer 220. This daily rate is generally the rate charged for a single 24 hour shift of nursing care. Generally, this can be anywhere from 2-4 nurses sharing this shift. The steps recited above are not necessarily performed in the order given, as the entering of information into computer system 220 can be done at various different times during a billing process.

In step 406, the microprocessor automatically calculates a cost per patient over a set period of time by determining the percentage of the daily rate for each nursing rotation to be assigned to each patient for each day, based on the numerical value of the services provided to each patient.

In step 407, the microprocessor automatically generates and sends an invoice for the cost of the nursing rotation to each patient. Generally, the invoices are calculated, generated and sent on a monthly basis, but other billing cycles could also be used. The invoices can be sent automatically by email or text message by server 221, or can be printed out and mailed to each patient.

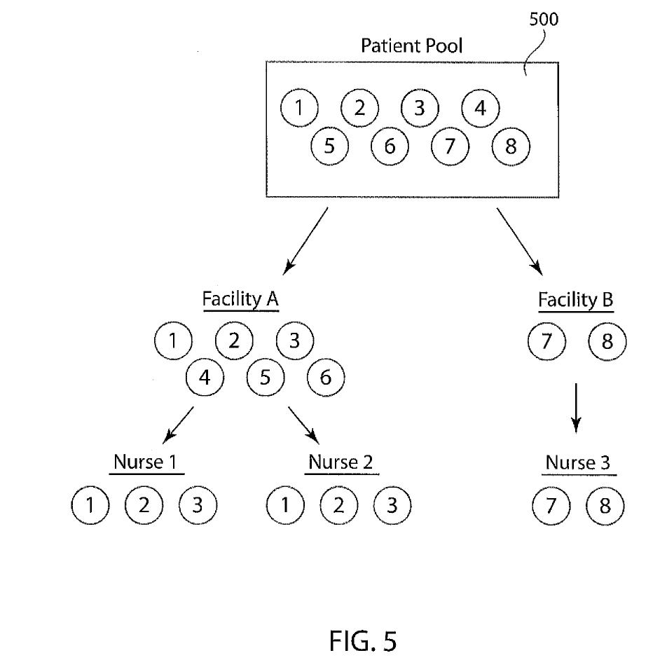

FIG. 5 is a decision tree showing how patients are allocated to each nursing rotation. A patient pool 500 consists of eight patients, who are grouped according to location in step 402 of the process. In facility A, there are 6 patients requesting nursing care, and in facility B, there are two patients requesting nursing care. The software program 209 has set a maximum number of patients per nursing rotation at 4, so in Facility A, two nursing rotations must be assigned by the microprocessor 221. The total patients are facility A are then divided between the two nursing rotations, so that each nurse 1, 2 is assigned to three patients. Microprocessor 221 performs this calculation automatically. Facility B has not reached the maximum number of patients, so only a single nurse 3 is assigned. As the patient pool changes over time, the number of nurses assigned to each facility changes, as do the number of patients. The microprocessor 221 is continuously re-evaluating the staffing at each facility to ensure that the proper number of nurses are assigned for each facility, based on the maximum patient load. This helps to keep the costs down for the patients, as they are sharing the costs with a larger number of other patients, while still receiving quality care.

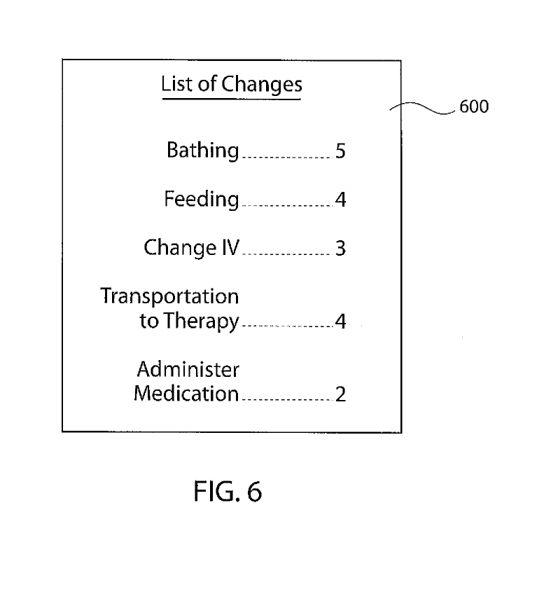

FIG. 6 shows a list of charges 600, showing a sample cost allocation for a variety of nursing services. Such an allocation is entered into computer 220 for use in calculating the costs to each patient. As shown in FIG. 6, each service is allocated a different numerical value, based on the difficulty or time each service takes. For example, administering medication is rated a 2, while bathing is rated a 5, so is comparatively more expensive to the patient.

The monthly bill to each patient is calculated as follows: Nurse 1 (i.e., a nursing rotation of a 24 hour shift) has three patients in a single facility, Patient 1, Patient 2 and Patient 3, as shown in FIG. 5. Patient 1 has used 240 units of nursing charges in the month of December, as calculated by the schedule of charges shown by example in FIG. 6. Patient 2 has used 310 units and Patent 3 has used 120 units. The daily rate for Nurse 1 is $400 for a 24 hour shift. Thus, for the month of December, the total nursing charge is $400×31 or $12,400. The total units used in December by patients 1-3 was 670. Thus, Patient 1 used 240/670 units, or 36% of the nursing charge. Patent 2 used 46% and patient 3 used 18%. Thus, the monthly bill to patent 1 is 36% of $12,400, or $4464. The monthly bills to patients 2 and 3 are $5704 and $2232, respectively. These charges can be calculated easily and automatically by the microprocessor 221, even if new patients are added mid-month, or if a patient uses only a part of a month's nursing care, as the bill only reflects the percentage of nursing care actually used.

Accordingly, while only a few embodiments of the present invention have been shown and described, it is obvious that many changes and modifications may be made thereunto without departing from the spirit and scope of the invention.

What is claimed is:

1. A method for billing shared healthcare services, comprising:
receiving in a database of a computer data of patients requesting care, said data including names and locations;
sorting the data via a software program installed on the computer and powered by a microprocessor of the computer to group the patients according to location;
automatically assigning the patients in a common location to a single healthcare rotation via the microprocessor;
entering in the database a list of common healthcare services provided by a healthcare rotation and a corresponding numerical value assigned to each one of said services;
entering into the database data regarding each service provided to each patient by each rotation in the common location;
automatically assigning via the microprocessor a numerical value to each entered service in the database based on the numerical values assigned to each common service in the database;
entering a daily rate for each rotation in the database;
automatically calculating by the microprocessor a cost per patient in the common location by determining the percentage of the daily rate for each rotation to be assigned to each patient based on the numerical value of the services provided to each patient; and
automatically generating an invoice for the cost of the rotation to each patient via the microprocessor.

2. The method according to claim 1, wherein the microprocessor assigns a maximum number of patients per rotation such that when the number of patients at a common location exceeds the maximum number, the microprocessor assigns an additional rotation and the number of patients is divided between the rotations.

3. The method according to claim 1, further comprising automatically sending an invoice to each patient by email or text message.

4. The method according to claim 1, wherein a rotation comprises three nurses sharing a 24 hour shift.

5. The method according to claim 3, wherein the microprocessor automatically assigns additional available patients in the same location to the rotation when the number of patients in the common location falls below the maximum number per rotation.

6. The method according to claim 1, wherein the step of entering the entering into the database data regarding each service provided to each patient by each rotation in the common location takes place by each nurse entering the data regarding each service into a personal computing device and sending said data over a wireless network to the database.

7. The method according to claim 1, further comprising the step of automatically sending patent identification data of patients assigned to a particular rotation via the microprocessor of the server to the personal computing device of the rotation covering said patients.

8. The method according to claim 6, wherein the personal computing device is a smartphone, a tablet computer or a personal computer.

9. A computerized system for providing and billing shared private healthcare services, comprising:
a computer system containing at least one server having a mass storage for storing a database, a memory, a microprocessor, and a wireless communication device configured for sending and receiving data over a wireless data network;
software installed on the mass storage of the server and communicating with the memory, microprocessor and wireless communication device, said software being configured to cause the microprocessor to sort patient data and group said patient data by location, assign a healthcare rotation to a group of patients at a single location and send said patient data to the assigned rotation over the wireless data network;
at least one personal computing device containing a microprocessor, a memory a mass storage and a mobile wireless communication device, said at least one personal computing device adapted to receive said patient data from the computer and display said data on the personal device, the device having an interface adapted to receive information regarding healthcare services provided to a patient as input by a healthcare provider in the rotation and said mobile wireless communication device being configured to send said information to the computer for storage in the database,
wherein the microprocessor of the server is further configured to assign a numerical value to each service received from the personal device and calculate a charge to a patient based upon a daily rate of each rotation and the number and value of services used by each patient.

10. The system according to claim 9, wherein the microprocessor of the computer is further configured to generate and invoice for each patient after a predetermined period of time.

11. The system according to claim 10, wherein the personal computing device is a smartphone, a tablet computer or a personal computer.
